(19) United States
(12) Patent Application Publication
(10) Pub. No.: US 2020/0039169 A1
(43) Pub. Date: Feb. 6, 2020

(54) Method of Manufacturing a Non-Rigid Container, and a Rigid Container Manufactured According to Said Method

(71) Applicant: The Wren Design (Pty) Limited, Cape Town (ZA)

(72) Inventor: Wendren Setzer, Cape Town (ZA)

(21) Appl. No.: 16/053,997

(22) Filed: Aug. 3, 2018

(51) Int. Cl. B31B 70/74; B31B 70/64; B31B 70/62

(52) U.S. Cl. CPC B31B 70/79; B31B 2155/00; B31B 70/62; B31B 70/64

(57) ABSTRACT

Described is a manufacturing a non-rigid container, the method including one or more of the following steps: coating a surface of a fabric with a water-based adhesive; leaving the product to cure for a predetermined period of time; temporarily adhering a paper to said adhesive surface of said fabric in a heat fusing press; cutting one or more required pattern pieces; stitching said one or more patters pieces together in a desired fashion; and coating said material with a hydrophobic coating.

### FIELD OF THE INVENTION

The present invention relates to a method of manufacturing a non-rigid container, and a rigid container manufactured according to said method.

### BACKGROUND TO THE INVENTION

A bag (also known regionally as a sack) is a common form of non-rigid container. For purposes of clarity, references to “bag” within this patent specification are to include stationary items such as book covers and wallets.

The use of bags predates recorded history, with the earliest bags being no more than lengths of animal skin, cotton, or woven plant fibers, folded up at the edges and secured in that shape with strings of the same material.

In the modern world, bags are ubiquitous, with many people routinely carrying a wide variety of them in the form of briefcases, handbags and backpacks. Conventionally, bags are manufactured from cloth (textile) or leather, with some made from more disposable materials such as plastic. A bag may conventionally be closable by a zipper, snap fastener or may be foldable. In addition, a bag may conventionally be securely closable.

Bags may be made from many materials, with four main sources including: animal materials (wool, silk), plant materials (cotton, flax, jute), minerals (asbestos, glass fibre), and synthetic materials (nylon, polyester, acrylic), to name a few.

There are environmental concerns regarding the use and disposal of disposable bags such as plastic shopping bags and trash bags. Efforts are being taken to control and reduce their use in some European Union countries. In some cases, the bags are taxed so the customer must pay a fee for their use, where they may not have been required to done so previously. Sometimes heavy duty reusable plastic and fabric bags are sold and these may replace disposable bags entirely.

For consumers the most common way of addressing environmental concerns and recycling is reuse through reselling or donating to charity (Goodwill Industries, Salvation Army, etc.).

Upcycling, also known as creative reuse, is the process of transforming by-products, waste materials, useless, or unwanted products into new materials or products of better quality or for better environmental value.

### OBJECT OF THE INVENTION

It is an object of the invention to provide a system for locating a supplier or service provider, and a method of enabling a consumer to locate a supplier or service provider which provides the advantages and addresses some of the issues and deficiencies described above.

### SUMMARY OF THE INVENTION

According to a first aspect of the invention, there is provided a method of manufacturing a non-rigid container, the method including one or more of the following steps:

coating a surface of a fabric with a water-based adhesive;

leaving the product to cure for a predetermined period of time;

adhering a paper to said adhesive surface of said fabric in a heat fusing press;

cutting one or more required pattern pieces;

stitching said one or more patters pieces together in a desired fashion; and

coating said material with a hydrophobic coating.

In an embodiment of the invention, said fabric is provided in the form of a 100% cotton calico 135 gsm or a poly-cotton blend, weave or twill.

In an embodiment of the invention, said paper is provided in the form of sack craft paper manufactured from a medium to low refined long fiber kraft pulp, with refining at high and forming a low consistency, granting fiber-to-fiber bonding with a high porosity. In this embodiment, said paper is dried with loose draws, allowing it to shrink in the dryer. Thus micro-creping is generated, which permits a high elongation before bursting providing the paper with a degree of stretch. In this embodiment, said paper is provided in the example form of 80 and 85 gsm extensible sack kraft paper, bleached or unbleached.

In an embodiment of the invention, said method includes the step of printing a pattern or design on said paper. In this embodiment, said printing includes screen printing, digital flat bed printing or stamping with one or more of the following: an alcohol-based ink, a specialised textile ink, a permanent archival ink or an oil-based ink.

In an alternative embodiment, said method includes the step of drawing on said paper using a permanent marker such as a Sharpie™ pen or Artline™ pen.

In an alternative embodiment, said method includes the step of painting on said paper using a non-water-based paint such as an Acrylic Drawing Ink.

In another alternative embodiment, said method includes the step of debossing, embossing and/or foiling said paper.

In an embodiment of the invention, said water-based adhesive is provided in the example form of a thermal acrylic polymer water-based adhesive.

In an embodiment of the invention, said step of coating a surface of a fabric includes passing said fabric through a roller process where a pressure of 80 pounds/sq inch is applied to the fabric at 100 degrees Celsius.

In an embodiment of the invention, said method includes the step of peeling a plastic sheet of said adhesive surface of said fabric.

In an embodiment of the invention, said heat fusing of said material and paper takes place at a pressure of between 1 Bar and 3 Bar. In this embodiment, said heat fusing of said material and paper takes place at a temperature of between 100 and 120 degrees Celsius. In this embodiment, pressure is applied to said material for between 10 to 15 seconds. In this embodiment, in response to a colder outside ambient temperature, a temperature or time period for pressing said material is increased.

In an embodiment of the invention, said method includes the step of sewing said material into a desired shape. In this embodiment, said step includes setting up a conventional sewing machine for light-weight sewing. In this embodiment, said step includes the use of needles of between 70 and 90 mm thickness with a 100% cotton or poly-cotton thread. In this embodiment, a stitch distance in respect of said sewn stitches varies between 2 and 4, depending on the machine options, product and seam location.

In this embodiment, said sewing machine is set up with a combination of the following: dropped teeth, a Teflon™ feed-dog, rubber feed-dog or Teflon™ foot. In this embodiment, said needle is recommended to be changed every 24 hours of use of the sewing machine in so far as said needle may become blunt from use in piercing said paper.

In an embodiment of the invention, said step of coating said material includes spraying said material with a hydroponic liquid repelling coating, in the example form of Nano Technology Textile Coating or Nano Silicon Dioxide (SiO2). In this example embodiment, said silicon dioxide coating has no effect on the optic and haptic (touch) of the material. In this example embodiment, said coating is water-based, free from alcohol and is harmless to the skin and environment in that it contains no harmful substances. In this example embodiment, said environmental friendly nature of said coating is verified independently in accordance with the Oeko-Tex™ Standard 100.

In this embodiment, said step of coating said material includes the step of spraying said coating onto the surface with a high-pressure gun, the nanoparticles form an ultra-thin non-polymer based matrix and bonds with the surface, so as to protect it from oil, water an dirt.

In an embodiment of the invention, said method may include the additional steps of applying one or more press studs, magnets, non-woven batting, embroider labels and brushed fabric.

According to a second aspect of the invention, there is provided a non-rigid container, said non-rigid container including one or more of the following:

a holder, cover or bag manufactured from a material including a bonded paper and fabric;

wherein said holder, cover or bag is manufactured according to a method of manufacturing a non-rigid container, as described with reference to embodiments of this invention.

### BRIEF DESCRIPTION OF THE DRAWINGS

The present invention will now be described, by way of example only, with reference to the accompanying drawings, in which:

FIG. 1 is schematic diagram of a method of manufacturing a non-rigid container, in accordance with an embodiment of the invention; and

FIG. 2 is a schematic diagram of a rigid container manufactured according to the method described with reference to FIG. 1, in accordance with an embodiment of the invention.

### DESCRIPTION OF PREFERRED EMBODIMENT

The following description of the invention is provided as an enabling teaching of the invention. Those skilled in the relevant art will recognise that many changes can be made to the embodiment described, while still attaining the beneficial results of the present invention. It will also be apparent that some of the desired benefits of the present invention can be attained by selecting some of the features of the present invention without utilizing other features. Accordingly, those skilled in the art will recognise that modifications and adaptations to the present invention are possible and can even be desirable in certain circumstances and are a part of the present invention. Thus, the following description is provided as illustrative of the principles of the present invention and not a limitation thereof.

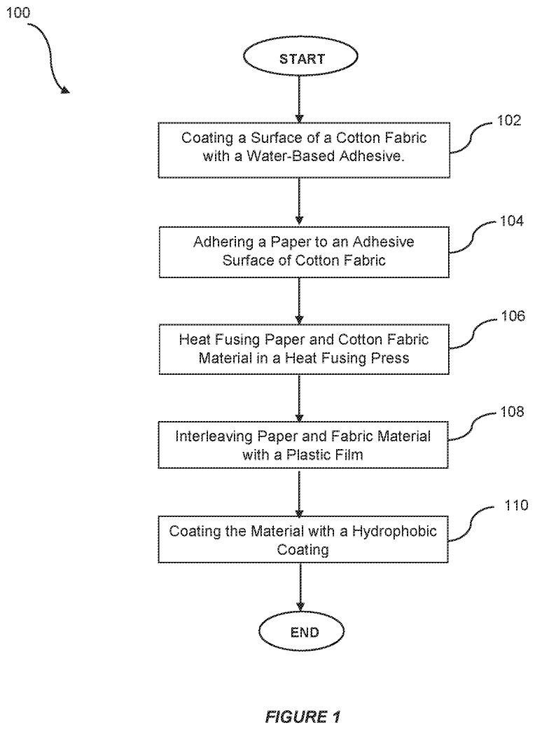

In FIG. 1, a method of manufacturing a non-rigid container, is generally described with reference to numeral 100.

The method 100 includes the step of coating a surface of a fabric with a water-based adhesive, at block 102. The fabric is then interleaved with plastic film, at block 102.1 and left to cure for 24 hours, at block 102.2.

At block 104, the method 100 includes the step of adhering a paper to an adhesive surface of fabric using heat.

At block 106, the method 100 includes the step of cutting the fabric into pattern pieces.

At block 108, the method 100 includes the step of stitching the fabric together.

At block 110, the method 100 includes the step of coating the material with a hydrophobic coating.

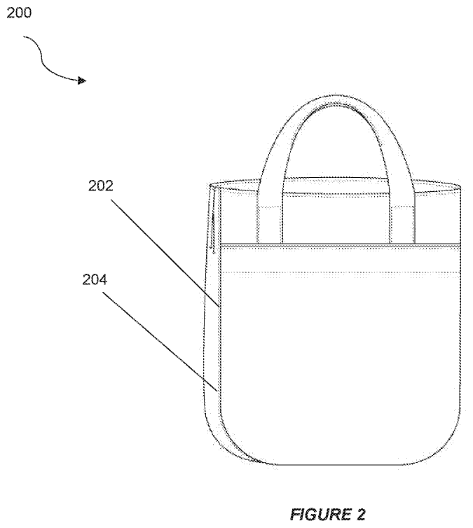

In FIG. 2, rigid container manufactured according to the method described with reference to FIG. 1, is generally described with reference to numeral 200.

The rigid container 200, is provided in the example form of a pouch, manufactured form a bonded paper 202 and fabric 204.

According to embodiments of the invention, the pouch 200 is manufactured according to a method of manufacturing a non-rigid container as set out with reference to FIG. 1 herein.

1. A method of manufacturing a non-rigid container, the method including the following steps:
coating a surface of a fabric with a water-based adhesive;
leaving the product to cure for a predetermined period of time;
temporarily adhering a paper to said adhesive surface of said fabric in a heat fusing press;
cutting one or more required pattern pieces;
stitching said one or more patters pieces together in a desired fashion; and
coating said material with a hydrophobic coating.

2. A method as claimed in claim 1, wherein said fabric is provided in the form of a 100% cotton calico 135 gsm or poly-cotton blend, weave or twill.

3. A method as claimed in claim 1, wherein said paper is provided in the form of sack craft paper manufactured from a medium to low refined long fiber kraft pulp, with refining at high and forming a low consistency, granting fiber-to-fiber bonding with a high porosity.

4. A method as claimed in claim 3, wherein said paper is dried with loose draws, allowing it to shrink in the dryer.

5. A method as claimed in claim 3, wherein said paper is provided in the example form of 80 and 85 gsm extensible sack kraft paper, bleached or unbleached.

6. A method as claimed in claim 1, wherein said method includes the step of printing a pattern or design on said paper.

7. A method as claimed in claim 6, wherein said printing includes screen printing, digital flatbed printing or stamping with one or more of the following: an alcohol-based ink, a specialised textile ink, a permanent archival ink or an oil-based ink.

8. A method as claimed in claim 6, wherein said method includes the step of drawing on said paper using a permanent marker such as a Sharpie™ pen or Artline™ pen.

9. A method as claimed in claim 6, wherein said method includes the step of painting on said paper using a non-water-based paint such as an Acrylic Drawing Ink.

10. A method as claimed in claim 6, wherein said method includes the step of debossing, embossing and/or foiling said material.

11. A method as claimed in claim 1, wherein said water-based adhesive is provided in the example form of a thermal acrylic polymer water-based adhesive.

12. A method as claimed in claim 1, wherein said step of coating a surface of a fabric includes passing said fabric through a roller process where a pressure of 80 pounds/square inch is applied to the fabric at 100 degrees Celsius.

13. A method as claimed in claim 12, wherein said method includes the step of peeling a plastic sheet of said adhesive surface of said fabric.

14. A method as claimed in claim 1, wherein said heat fusing of said fabric and paper takes place at a pressure of between 1 Bar and 3 Bar.

15. A method as claimed in claim 14, wherein said heat fusing of said fabric and paper takes place at a temperature of between 100 and 120 degrees Celsius.

16. A method as claimed in claim 1, wherein said step of coating said material includes spraying said material with a hydroponic liquid repelling coating, in the example form of Nano Technology Textile Coating or Nano Silicon Dioxide (SiO2).

17. A method as claimed in claim 16, wherein said coating is water-based, free from alcohol and is harmless to the skin and environment in that it contains no harmful substances.

18. A method as claimed in claim 17, wherein said environmental friendly nature of said coating is verified independently in accordance with the Oeko-Tex™ Standard 100.

19. A method as claimed in claim 18, wherein said step of coating said material includes the step of spraying said coating onto the surface with a high-pressure gun, the nanoparticles form a ultra-thick non-polymer based matrix and bonds with the surface, so as to protect it from oil, water an dirt.

20. A non-rigid container wherein said non-rigid container including one or more of the following:
a holder, cover or bag manufactured form a material including a bonded paper and fabric;
wherein said holder, cover or bag is manufactured according to a method of manufacturing a non-rigid container, as described with reference to embodiments of this invention.
